(19) United States
(12) Patent Application Publication
(10) Pub. No.: US 2019/0285822 A1
(43) Pub. Date: Sep. 19, 2019

(54) CONNECTION STRUCTURE AND METHOD OF PRODUCING CONNECTION STRUCTURE

(71) Applicant: FUJIKURA LTD., Tokyo (JP)

(72) Inventors: Yuichi Yoshida, Chiba (JP); Norihiro Momotsu, Chiba (JP); Katsushi Agata, Chiba (JP)

(73) Assignee: FUJIKURA LTD., Tokyo (JP)

(21) Appl. No.: 16/287,843

(22) Filed: Feb. 27, 2019

(30) Foreign Application Priority Data
Mar. 14, 2018 (JP) 2018-046588

(51) Int. Cl. G02B 6/44

(52) U.S. Cl. CPC G02B 6/4476; G02B 6/443

(57) ABSTRACT

A connection structure includes: a closure including an introduction tube; at least two optical cables inserted through the introduction tube; a seal that closes a gap between the introduction tube and each of the optical cables; and a holder disposed on a side opposite to the closure when seen from the seal. The holder fixes the at least two optical cables over a predetermined length.

### CROSS-REFERENCE TO RELATED APPLICATIONS

The present application claims priority upon Japanese Patent Application No. 2018-046588 filed on Mar. 14, 2018, which is herein incorporated by reference.

### TECHNICAL FIELD

The present invention relates to a connection structure and a method of producing a connection structure.

### BACKGROUND

JP 2005-242143A, U.S. Pat. No. 4,085,286, and JP 2013-130718A describe a closure that houses and protects a connecting section of optical fibers. JP 2013-130718A describes that two optical cables are inserted through cable holes of a closure and also inserted inside a heat-shrinkable tube, and that in this state, the closure is sealed by heating the heat-shrinkable tube. JP 2013-130718A describes that a clip with a hot melt adhesive sandwiches an edge of a heat-shrinkable tube between two optical cables before the heat-shrinkable tube is heated, and a gap between the heat-shrinkable tube after heating and the optical cables is then sealed with the hot melt adhesive.

A known optical cable relatively has flexibility. Thus, even when bending force or twisting force is applied to an optical cable extending from a closure, the force is less likely to be transmitted to a part (seal part) that seals the closure with a heat-shrinkable tube. On the other hand, the number of optical fibers included in an optical cable tends to be significantly increasing in recent years. Such an ultra-high-fiber-count optical cable tends to have rigidity higher than that of a known optical cable. Then, when optical cables having high rigidity are introduced in a closure and the closure is sealed by using a heat-shrinkable tube, bending force and twisting force applied to any of or both the optical cables are transmitted to a seal part. Accordingly, the seal part may be damaged and waterproof property may decrease.

### SUMMARY

Embodiments of the invention provide a structure that can suppress damage to a seal part even when force is applied to an optical cable.

According to one or more embodiments of the invention, a connection structure includes: a closure including a tubular introduction part; at least two optical cables inserted through the introduction part; a seal part that closes a gap between the introduction part and each of the optical cables; and a holding part that is provided to a side opposite to the closure when seen from the seal part, the holding part fixing the two optical cables over a predetermined length.

Other features of the invention are made clear by the following description and the drawings.

With the present invention, it is possible to suppress damage to a seal part even when force is applied to an optical cable.

### BRIEF DESCRIPTION OF DRAWINGS

FIG. 1 is a perspective view of a closure 1 according to one or more embodiments.

FIG. 2 is an exploded view of the closure 1 according to one or more embodiments.

FIG. 3 is a perspective view of a connection structure 100 according to one or more embodiments.

FIGS. 4A and 4B are explanatory diagrams illustrating the connection structure 100 according to one or more embodiments.

FIG. 5 is a cross-sectional view of an optical cable 40 according to one or more embodiments.

FIG. 6 is a perspective view of a clip 60 before heating according to one or more embodiments.

FIGS. 7A to 7E are explanatory diagrams illustrating a method of producing the connection structure 100 according to one or more embodiments.

FIGS. 8A to 8D are explanatory diagrams illustrating steps of producing a seal part 50 according to one or more embodiments.

FIGS. 9A and 9B are explanatory diagrams illustrating steps of producing a holding part 70 according to one or more embodiments.

FIGS. 10A and 10B are explanatory diagrams illustrating a connection structure 100 according to one or more embodiments.

### DETAILED DESCRIPTION

At least the following matters are made clear from the following description and the drawings.

Disclosed is a connection structure including: a closure including a tubular introduction part (introduction tube); at least two optical cables inserted through the introduction part; a seal part (seal) that closes a gap between the introduction part and each of the optical cables; and a holding part (holder) that is provided to a side opposite to the closure when seen from the seal part, the holding part fixing the two optical cables over a predetermined length. With this connection structure, it is possible to suppress damage to the seal part even when a force is applied to any of or both the optical cables.

In one or more embodiments: the seal part is constituted by a heat-shrinkable tube shrinking by heat and a hot melt adhesive filling inside the heat-shrinkable tube. In this way, the seal part can be formed by closing a gap with the hot melt adhesive melted when the heat-shrinkable tube is heated.

In one or more embodiments: the holding part is constituted by a heat-shrinkable tube. In this way, the heat-shrinkable tube shrinks by heat to fix the two optical cables over a predetermined length, so that the holding part can be formed.

In one or more embodiments: the heat-shrinkable tube forming the seal part and the heat-shrinkable tube forming the holding part are constituted by a same member. In this way, types of parts can be reduced.

In one or more embodiments: the optical cables are provided with a first protective part (first protector) that protects the optical cables when the heat-shrinkable tube forming the seal part shrinks by heat and a second protective part (second protector) that protects the optical cables when the heat-shrinkable tube forming the holding part shrinks by heat. In this way, damage to outer sheaths of the optical cables can be suppressed when the heat-shrinkable tube is heated.

In one or more embodiments: the first protective part is provided to an edge of the heat-shrinkable tube forming the seal part and to an edge of the heat-shrinkable tube forming the holding part. This facilitates formation of a protective part further than a case where separate protective parts are provided at respective edges.

In one or more embodiments: the holding part is constituted by two half members each including a groove in which the optical cables are disposed. This facilitates the operation of forming a holding part.

Disclosed is a method of producing a connection structure including: inserting at least two optical cables through a tubular introduction part of a closure; forming a seal part that closes a gap between the introduction part and each of the optical cables; and forming a holding part that fixes the two optical cables over a predetermined length to a side opposite to the closure when seen from the seal part. With this method of producing a connection structure, it is possible to produce the connection structure that can suppress damage to the seal part even when a force is applied to the optical cable.

Configuration of Closure 1

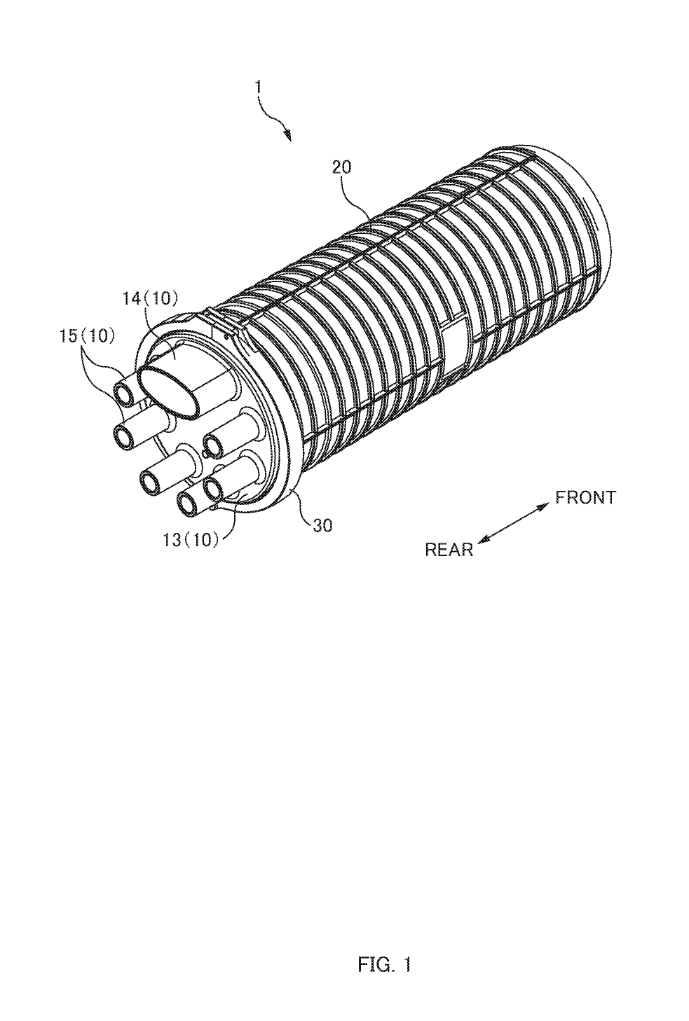

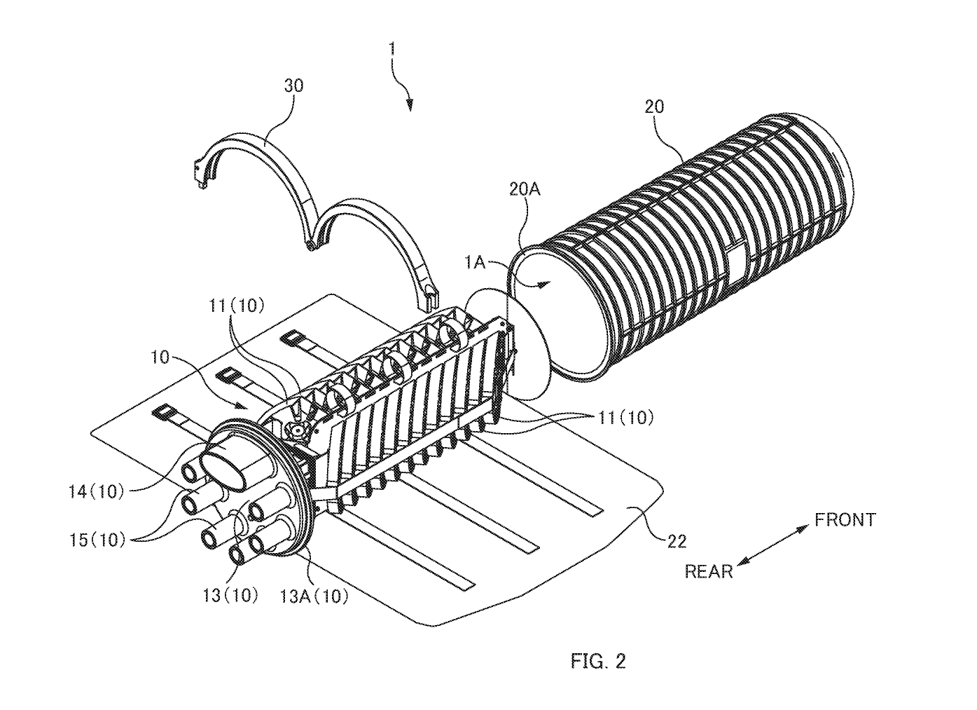

FIG. 1 is a perspective view of a closure 1 according to one or more embodiments. FIG. 2 is an exploded view of the closure 1 according to one or more embodiments.

In the following description, a front-and-rear direction is defined as indicated by an arrow in drawings. Specifically, a direction in which a main introduction part 14 extends represents the “front-and-rear direction”, a closure body side when seen from the main introduction part 14 represents the “front”, and an opening side (side from which an optical cable extends) of the main introduction part 14 represents the “rear”.

The closure 1 in one or more embodiments is a so-called pot-type closure. The closure 1 includes a base part 10, a cover 20, and a fixing member 30.

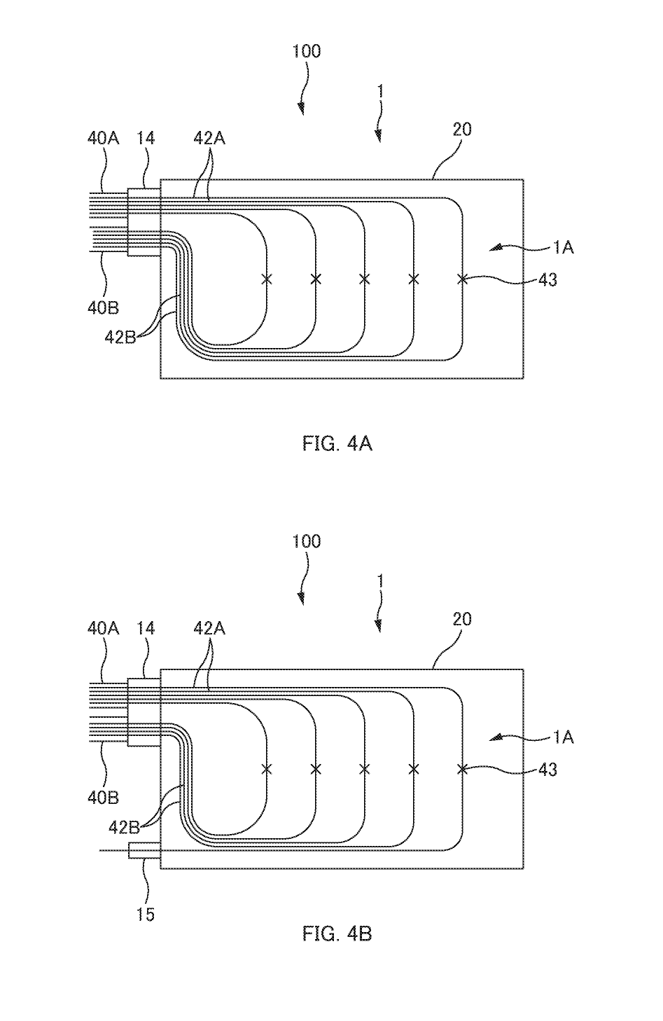

The base part 10 is a part that holds a connecting section 43 for optical fibers 42 (cf. FIG. 4A) and optical cables 40. The base part 10 includes a plurality of housing trays 11 and an end face plate 13.

Each housing tray 11 is a tray that houses the connecting section 43 (cf. FIG. 4A) of the optical fibers 42. The housing tray 11 may house an extra length of the optical fibers 42. A large number of the housing trays 11 are disposed on the base part 10. Each of the housing trays 11 can house a plurality of connecting sections 43 (cf. FIG. 4A).

The end face plate 13 is a plate-shaped part in an end part of the base part 10. The end face plate 13 includes the main introduction part 14 and an auxiliary introduction part 15. Further, a gasket part 13A is formed at an outer edge of the end face plate 13.

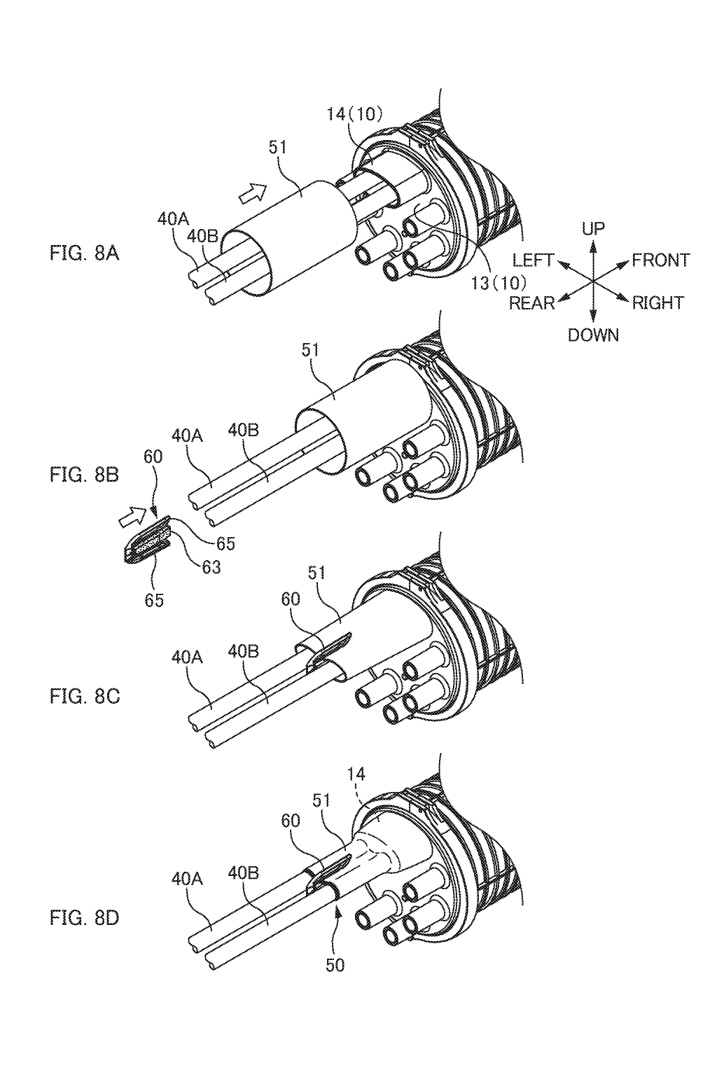

The main introduction part 14 is a part that allows the optical cables (cf. FIG. 4A) to be introduced inside the closure 1. The main introduction part 14 is a tubular part (tube part) protruding from the end face plate 13 to the outside (rear side). The main introduction part 14 is formed such that a section thereof is elliptic, and allows two aligned optical cables 40 to be introduced inside the closure 1 (cf. FIG. 8A). An elliptic main introduction hole (through hole) is formed in the end faceplate 13 on the inside of the main introduction part 14. Note that, the optical cables 40 inserted through the main introduction part 14 may be referred to as a main cable.

The auxiliary introduction part 15 is a part that allows an optical cable to be introduced inside the closure 1. The auxiliary introduction part 15 is a tubular part (tube part) protruding from the end face plate 13 to the outside (rear side). The auxiliary introduction part 15 is a tubular part having a cross-sectional area smaller than that of the main introduction part 14. The auxiliary introduction part 15 is formed such that a section thereof is circular, and allows an optical cable thinner than the optical cables 40 introduced through the main introduction part 14 to be introduced inside the closure 1. A circular auxiliary introduction hole (through hole) is formed in the end faceplate 13 on the inside of the auxiliary introduction part 15. Note that, the optical cable inserted through the auxiliary introduction part 15 may be referred to as a branch cable.

The cover 20 is a cover that protects the housing trays 11 of the base part 10. A space surrounded by the cover 20 and the end face plate 13 of the base part 10 is a housing space 1A of the closure 1, and the large number of the housing trays 11 is housed in the housing space 1A. Note that, as described later, a gap of the closure 1 is sealed such that the housing space 1A inside the cover 20 is tightly enclosed. A gasket part is formed at an outer edge of an opening 20A of the cover 20. In one or more embodiments, after a sheet 22 is wrapped around the large number of the housing trays 11, the cover 20 is attached so as to cover the outside of the housing trays 11. However, the cover 20 maybe attached so as to cover the outside of the housing trays 11 without the sheet 22 wrapped around the housing trays 11.

The fixing member 30 is a member that fixes the cover 20 to the base part 10 while closing the gap between the end face plate 13 of the base part 10 and the opening 20A of the cover 20. Waterproofness and airtightness of the housing space 1A of the closure 1 are secured by the fixing member 30 sealing between the gasket part 13A of the end face plate 13 of the base part 10 and the gasket part at the outer edge of the opening 20A of the cover 20. Here, the fixing member 30 is constituted by two semicircular arc-shaped members connected with a hinge, and is formed such that end parts of the two semicircular arc-shaped members are engaged on the opposite side from the hinge. The fixing member 30 is attached to the base part 10 and the cover 20 while sealing between the gasket part 13A of the end face plate 13 of the base part 10 and the gasket part at the outer edge of the opening 20A of the cover 20. However, the configuration of the fixing member 30 is not limited to this.

Connection Structure 100

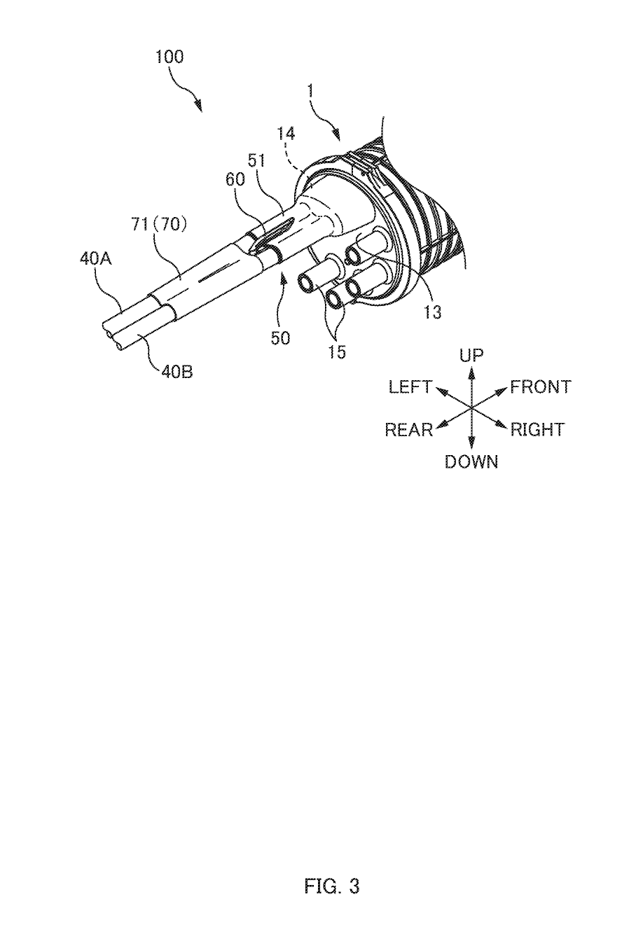

FIG. 3 is a perspective view of the connection structure 100 according to one or more embodiments. FIGS. 4A and 4B are explanatory diagrams illustrating the connection structure 100 according to one or more embodiments.

In the following description, directions are defined as illustrated in FIG. 3. The “front-and-rear direction” is as already described above, and is identical to the direction indicated by the arrow in FIG. 1. A direction in which the two optical cables 40 are aligned represents a “left-and-right direction”, the right side when seeing the front side from the rear side represents the “right”, and the opposite side is the “left”. A direction vertical to the front-and-rear direction and the left-and-right direction represents an “up-and-down direction.”

The connection structure 100 is a structure that houses the connecting section 43 for the optical fibers 42 of the optical cables 40 inside the closure 1. The connection structure 100 includes the closure 1, the two optical cables 40, a seal part 50, and a holding part 70. The configuration of the closure 1 is as already described above.

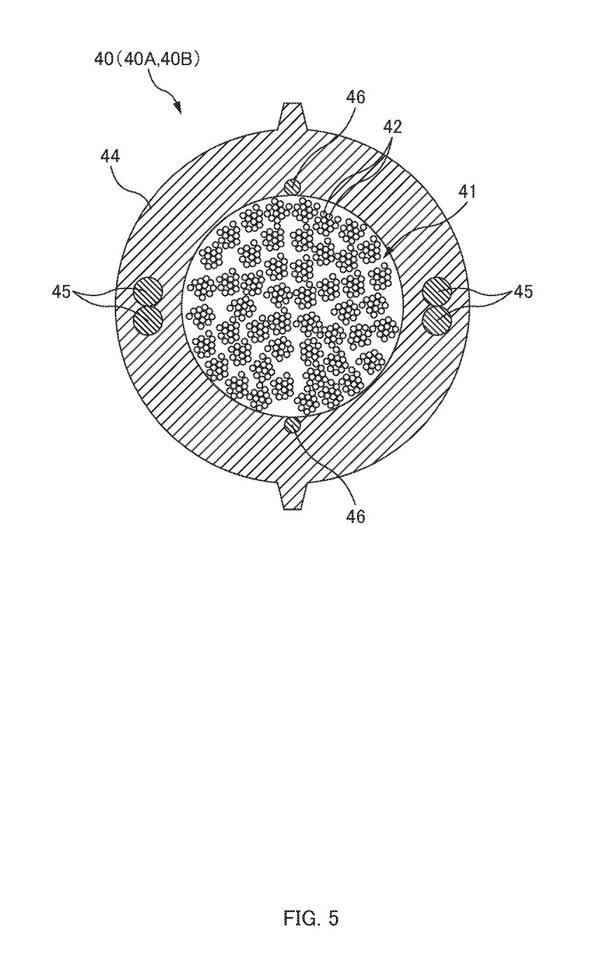

FIG. 5 is a cross-sectional view of each optical cable 40 according to one or more embodiments. The optical cable 40 according to one or more embodiments is formed as a high-density slotless cable. The two optical cables 40 are inserted through the main introduction part 14. In the following description, one of the two optical cables 40 inserted through the main introduction part 14 may be referred to as an optical cable 40A, and the other of the optical cables 40 may be referred to as an optical cable 40B. Each optical cable 40 includes a large number of the optical fibers 42 and an outer sheath 44.

In one or more embodiments, the optical cable 40 is formed such that a plurality of optical fiber ribbons 41 of intermittently connected type are housed in the outer sheath 44. The optical fiber ribbon 41 of the intermittently connected type is the optical fiber ribbon 41 that intermittently connects the plurality of optical fibers 42 being aligned. The two optical fibers 42 adjacent to each other are connected with a connection part. A plurality of connection parts that connect the two optical fibers 42 adjacent to each other are disposed intermittently in a length direction. Also, the plurality of connection parts of the optical fiber ribbons 41 are disposed two-dimensionally and intermittently in the length direction and a ribbon width direction. The connection part is formed by applying ultraviolet-curable resin as an adhesive and then curing the ultraviolet-curable resin by irradiation with ultraviolet light. Note that the connection part may also be made of thermoplastic resin. A region except for the connection part between the two optical fibers 42 adjacent to each other is a non-connected part (separation part). The two optical fibers 42 adjacent to each other are not restricted in the non-connected part. The non-connected part is disposed in the width direction with respect to the position in which the connection part is formed. In this way, the optical fiber ribbon 41 can be rolled and tied in a bundle and the large number of the optical fibers 42 can be housed at a high density. For example, the optical cable 40 with several thousands of fibers can be formed by housing a large number of 12-fiber optical fiber ribbons 41 of an intermittently connected type.

The outer sheath 44 is a member that houses the plurality of optical fibers 42 therein. The outer sheath 44 is formed by performing extrusion molding on molten resin. A wrapping tape may be wrapped around a bundle of the plurality of optical fibers 42 in order to prevent the optical fibers 42 from being covered with molten resin. A tensile member 45 and a rip cord 46 are embedded in the outer sheath 44. A pair of tensile members 45 are disposed so as to sandwich a housing space (housing space that houses the optical fibers 42) of the outer sheath 44. Here, two tensile members 45 form one pair, and two pairs of the tensile members 45 are embedded in the outer sheath 44 so as to sandwich the housing space. However, one tensile member 45 instead of two may be located on one side, and two tensile members 45 may be embedded in the outer sheath 44 so as to sandwich the housing space.

As illustrated in FIG. 4A, the two optical fibers 42 are introduced inside the closure 1 through the main introduction part 14. Optical fibers 42A of the optical cable 40A of the main introduction part 14 and optical fibers 42B of the optical cable 40B of the main introduction part 14 are fusion-bonded inside the closure 1. The connecting section 43 (fusion-bonded section) of the optical fibers 42 is housed in the housing tray 11 (not illustrated in FIG. 4A, and cf. FIG. 2). As illustrated in FIG. 4B, the optical fibers 42A of the optical cable 40A (or the optical cable 40B) of the main introduction part 14 may be connected to the optical fibers of the optical cable of the auxiliary introduction part 15. This connecting section 43 is also housed in the housing tray 11 (not illustrated in FIG. 4B, and cf. FIG. 2). The connecting section 43 is not limited to the fusion-bonded section, and may use a mechanical splice.

The seal part 50 (cf. FIG. 3) is a part that closes the gap between the main introduction part 14 and the optical cables 40. The seal part 50 is constituted by a first heat-shrinkable tube 51 and a clip 60.

The first heat-shrinkable tube 51 is a tube that shrinks by heat. The first heat-shrinkable tube 51 has a function of reducing a gap around the main introduction part 14 and the optical cables 40 by heat shrinkage. The two optical cables 40 are inserted through the first heat-shrinkable tube 51. The first heat-shrinkable tube 51 has a length greater than a length of the main introduction part 14 (length from the end faceplate 13 to a rear edge of the main introduction part 14). A front part of the first heat-shrinkable tube 51 is disposed so as to cover the outside of the main introduction part 14. A rear part of the first heat-shrinkable tube 51 is disposed so as to cover the outside of the two optical cables 40 inserted through the main introduction part 14. In this way, a step part formed by the rear edge of the main introduction part 14 and the two optical cables 40 is covered in a central part of the first heat-shrinkable tube 51. As described later, by being heated and shrinking, the first heat-shrinkable tube 51 is fixed to the main introduction part 14 so as not to generate a gap between the first heat-shrinkable tube 51 and the main introduction part 14 in the front part of the first heat-shrinkable tube 51, and fixed to the two optical cables 40 so as not to generate a gap between the first heat-shrinkable tube 51 and the optical cables 40 on the rear side.

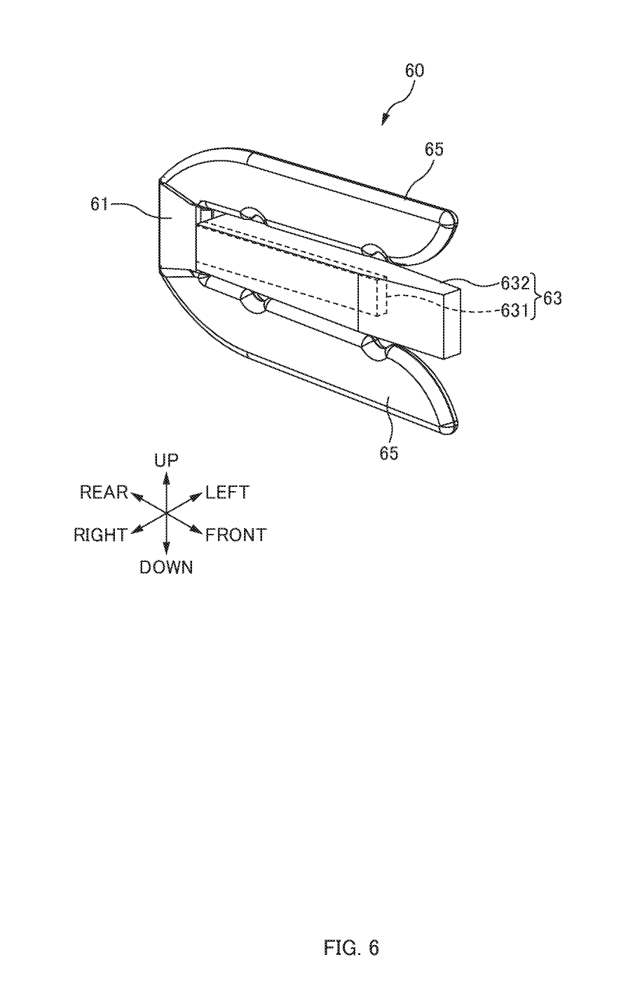

The clip 60 is attached to a rear edge of the first heat-shrinkable tube 51. FIG. 6 is a perspective view of the clip 60, according to one or more embodiments, before heating. In FIG. 6, directions are indicated by arrows according to respective directions (cf. FIG. 3) when the clip 60 is attached.

The clip 60 is a member that closes a gap between the two optical cables 40 at the rear edge of the first heat-shrinkable tube 51. As described later, the clip 60 is also a member that holds and sandwiches the rear edge of the first heat-shrinkable tube 51 before heating. The clip 60 includes a basic part 61, an insertion part 63, and a pair of sandwiching parts 65. The basic part 61 is a part that maintains the insertion part 63 and the sandwiching parts 65 to be integrated together. The insertion part 63 and the sandwiching parts 65 extend from the basic part 61 toward the front. In this way, the clip 60 has a trifurcated shape (shape divided into three branches).

The insertion part 63 is a part to be inserted inside the first heat-shrinkable tube 51. The insertion part 63 includes a core part 631 and a hot melt adhesive 632. The core part 631 is a rod-like part extending from the basic part 61 toward the front. One end (rear end) of the core part 631 is fixed to the basic part 61, and the other end (front end) is a free end. The hot melt adhesive 632 formed in a rod-like shape is fixed around the core part 631. The hot melt adhesive 632 is melted when the first heat-shrinkable tube 51 is heated, seals the gap at the rear edge of the first heat-shrinkable tube 51 as illustrated in FIG. 3, and forms the seal part 50.

The sandwiching parts 65 are parts that sandwich the first heat-shrinkable tube 51 between the insertion part 63 (or the core part 631) and the sandwiching parts 65. Each sandwiching part 65 is a rod-like or a plate-like part extending from the basic part 61 toward the front. One end (rear end) of the sandwiching part 65 is fixed to the basic part 61, and the other end (front end) is a free end. A gap is formed between each of the sandwiching parts 65 and the insertion part 63, and the rear edge of the first heat-shrinkable tube 51 is inserted in this gap to be sandwiched. The pair of the sandwiching parts 65 are disposed across the insertion part 63 in the up-and-down direction.

As illustrated in FIG. 3, the clip 60 is disposed so as to sandwich the rear edge of the first heat-shrinkable tube 51 in the up-and-down direction between the two optical cables 40. An upper rear edge of the first heat-shrinkable tube 51 is sandwiched between the core part 631 and the upper sandwiching part 65 of the clip 60. A lower rear edge of the first heat-shrinkable tube 51 is sandwiched between the core part 631 and the lower sandwiching part 65 of the clip 60. The gap between the first heat-shrinkable tube 51 and the optical cables 40 and the gap between the two optical cables 40 are sealed by the hot melt adhesive 632 melted when the first heat-shrinkable tube 51 is heated, and the seal part 50 is thus formed.

In this way, the rear edge of the first heat-shrinkable tube 51 having shrunk by heat, the clip 60, and the cured hot melt adhesive 632 after melting form the seal part 50. However, the configuration of the seal part 50 is not limited to this as long as the seal part 50 has a configuration in which the gap between the main introduction part 14 and the optical cables 40 can be sealed. For example, the seal part 50 may be formed by the first heat-shrinkable tube 51 having shrunk by heat and the hot melt adhesive filling inside of the first heat-shrinkable tube 51 without using the clip 60.

The optical cable 40 (ultra-high-fiber-count high-density slotless cable) used in one or more embodiments is constituted with the outer sheath 44 having relatively high rigidity, and thus has rigidity higher than that of a known optical cable. When bending force or twisting force is applied to the optical cable 40 having high rigidity, the force is likely to be transmitted to other parts of the optical cable 40. Thus, when bending force or twisting force is applied to the optical cable 40 in one or more embodiments, the force is likely to be transmitted to the seal part 50, which may damage the seal part 50 and decrease waterproof property. Accordingly, in one or more embodiments, the holding part 70 is provided to the rear side of the seal part 50 (to the side opposite to the closure 1 when seen from the seal part 50), and force applied to the seal part 50 is suppressed with the holding part 70.

The holding part 70 is a member that is provided to the rear side of the seal part 50 (to the side opposite to the closure 1 when seen from the seal part 50) and fixes the two optical cables 40 over a predetermined length. The holding part 70 thus fixing the two optical cables 40 over a predetermined length suppresses transmission of bending force, twisting force, or the like to the seal part 50. In one or more embodiments, the holding part 70 is constituted by a second heat-shrinkable tube 71 shrinking by heat.

The second heat-shrinkable tube 71 is a tube that shrinks by heat, similarly to the first heat-shrinkable tube 51. The two optical cables 40 are inserted through the second heat-shrinkable tube 71. The second heat-shrinkable tube 71 shrinks by heat while the two optical cables 40 are inserted therein, and thus the two optical cables 40 are tied in a bundle by the second heat-shrinkable tube 71. The two optical cables 40 are also fixed by the second heat-shrinkable tube 71 over a predetermined length in the front-and-rear direction (length direction). In other words, the two optical cables 40 are fixed over a predetermined length while being maintained to be aligned by the second heat-shrinkable tube 71. As a result, even when bending force or twisting force is applied to the optical cable(s) 40 on the rear side with respect to the second heat-shrinkable tube 71, the force is less likely to be transmitted to the seal part 50.

For example, even when bending force is applied to one optical cable 40A on the rear side with respect to the second heat-shrinkable tube 71, the two optical cables 40 in the bundle are fixed by the second heat-shrinkable tube 71, and thus the bending force is absorbed in the integrated structure of the second heat-shrinkable tube 71 and the two optical cables 40, and the bending force applied to the optical cable 40A is less likely to be transmitted to the seal part 50. Further, even when twisting force is applied to one optical cable 40A on the rear side with respect to the second heat-shrinkable tube 71, the two optical cables 40 in the bundle are fixed by the second heat-shrinkable tube 71, and thus the twisting force is absorbed in the integrated structure of the second heat-shrinkable tube 71 and the two optical cables 40, and the twisting force applied to the optical cable 40A is less likely to be transmitted to the seal part 50.

In one or more embodiments, the second heat-shrinkable tube 71 before heating is constituted by the same member as that for the first heat-shrinkable tube 51 before heating. In this way, types of parts can be reduced, and an operation (described later) of an operator is facilitated. Here, the second heat-shrinkable tube 71 may have a shape different from that of the first heat-shrinkable tube 51 (the second heat-shrinkable tube 71 and the first heat-shrinkable tube 51 may be different from each other in length and diameter). As described later, the holding part 70 may also be constituted by a member different from that for the second heat-shrinkable tube 71.

Method of Producing Connection Structure 100

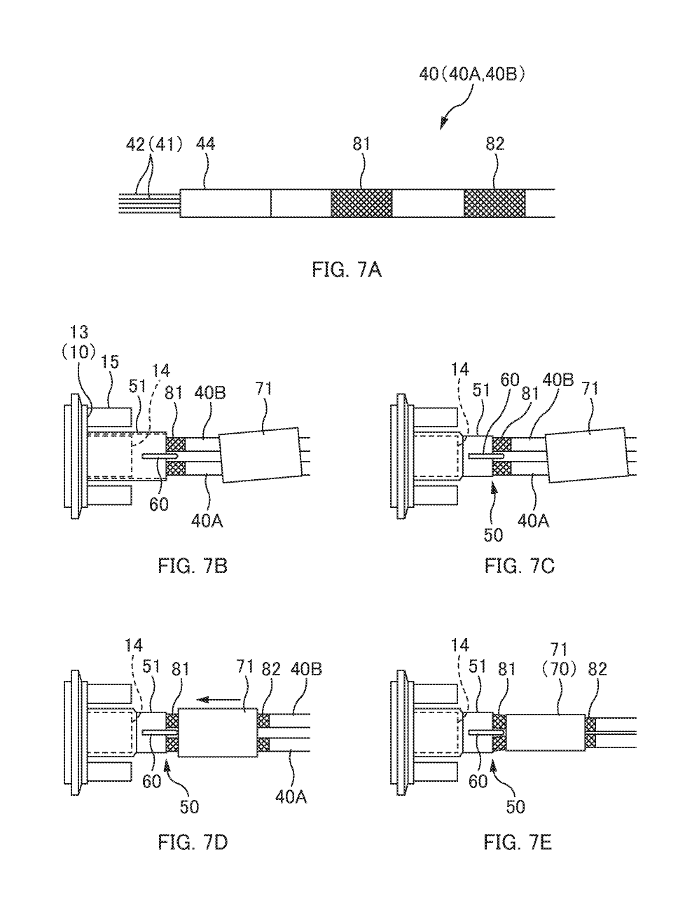

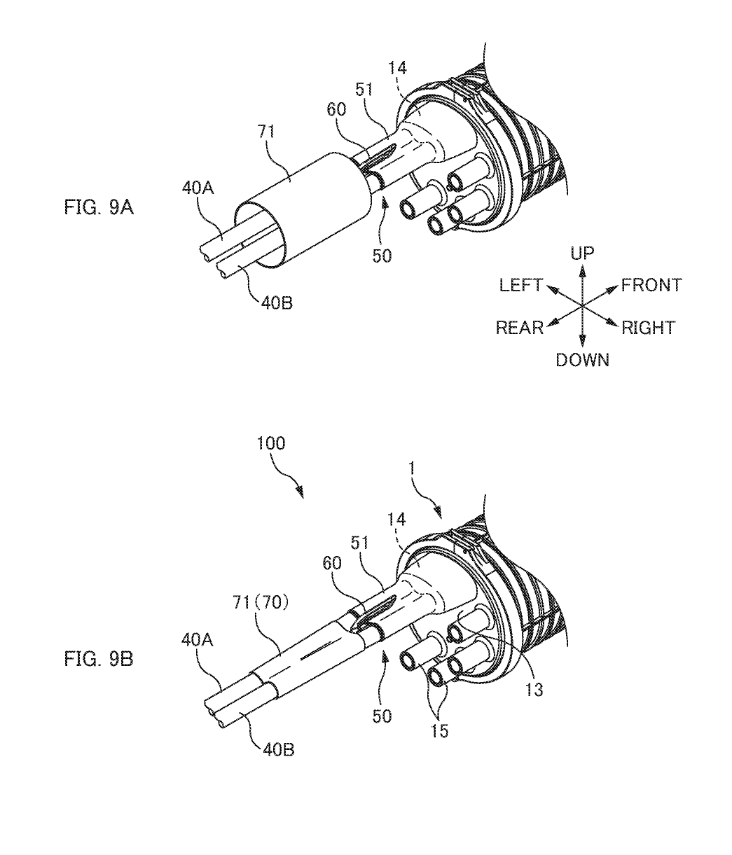

FIGS. 7A to 7E are explanatory diagrams illustrating a method of producing the connection structure 100 according to one or more embodiments. FIGS. 8A to 8D are explanatory diagrams illustrating steps of producing the seal part 50 according to one or more embodiments. FIGS. 9A and 9B are explanatory diagrams illustrating steps of producing the holding part 70 according to one or more embodiments.

First, as illustrated in FIG. 7A, an operator performs preprocessing on each optical cable 40. In this operation, the operator removes the outer sheath 44 of a predetermined length for an end part of the optical cable 40, and leads the optical fibers 42 of a predetermined length. After the leading operation, the operator wraps an aluminum tape around the outer periphery of the outer sheath 44 in a position to the rear by a predetermined distance from a leading part (end part of the outer sheath 44) as a reference position, to form a first protective part 81 of a predetermined length. The operator wraps an aluminum tape around the outer periphery of the outer sheath 44 in a position to the rear by a predetermined distance from the leading part (end part of the outer sheath 44) as a reference position, to form a second protective part 82 of a predetermined length. The second protective part 82 is formed to the rear by a predetermined length with respect to the first protective part 81. The aluminum tape has excellent heat insulation. The first protective part 81 and the second protective part 82 have a function of protecting the outer sheath 44 of the optical cable 40 during heating described later.

Next, the operator inserts the two optical cables 40 through the first heat-shrinkable tube 51 and the second heat-shrinkable tube 71 in advance, and then inserts the two optical cables 40 through the main introduction part 14 of the closure 1. In one or more embodiments, since the first heat-shrinkable tube 51 and the second heat-shrinkable tube 71 before heating are constituted by the same member, the operator can only insert the optical cables 40 through the two heat-shrinkable tubes without concern for types and order of the two heat-shrinkable tubes. This facilitates operation.

Next, as illustrated in FIG. 8A, the operator moves the first heat-shrinkable tube 51 previously put to the front. In this way, as illustrated in FIG. 8B, the outside of the main introduction part 14 is covered by the front part of the first heat-shrinkable tube 51. The first heat-shrinkable tube 51 has a length longer than a length of the main introduction part 14, and thus the outside of the two optical cables 40 inserted through the main introduction part 14 is covered by the rear part of the first heat-shrinkable tube 51. Note that, since the first heat-shrinkable tube 51 is before heating, the first heat-shrinkable tube 51 and the main introduction part 14 have a gap therebetween. Further, since the first heat-shrinkable tube 51 is before heating, the first heat-shrinkable tube 51 and the optical cables 40 also have a gap therebetween.

Next, the operator puts the clip 60 between the two optical cables 40 and moves the clip 60 to the front as illustrated in FIG. 8B, and the clip 60 sandwiches an upper rear edge and a lower rear edge of the first heat-shrinkable tube 51 between the two optical cables 40 as illustrated in FIG. 8C. At this time, the insertion part 63 (cf. FIG. 6) of the clip 60 is disposed inside the first heat-shrinkable tube 51, and the sandwiching parts 65 of the clip 60 are disposed outside the first heat-shrinkable tube 51. The upper rear edge of the first heat-shrinkable tube 51 is sandwiched between the insertion part 63 and the upper sandwiching part 65 of the clip 60. The lower rear edge of the first heat-shrinkable tube 51 is also sandwiched between the insertion part 63 and the lower sandwiching part 65 of the clip 60. In this way, the clip 60 holds the rear edge of the first heat-shrinkable tube 51 before heating and sandwiches the upper and lower edges.

Next, the operator heats the first heat-shrinkable tube 51 to shrink. For example, the operator heats the first heat-shrinkable tube 51 by using a burner. As illustrated in FIG. 8D, the heated first heat-shrinkable tube 51 shrinks, and thus the first heat-shrinkable tube 51 closely adheres to the main introduction part 14 at the front of the first heat-shrinkable tube 51 and is fixed to the main introduction part 14. Moreover, due to the shrinking of the heated first heat-shrinkable tube 51, the first heat-shrinkable tube 51 closely adheres to the optical cables 40 in the rear of the first heat-shrinkable tube 51 and is fixed to the two optical cables 40. Note that, a hot melt adhesive (not illustrated) is applied to the inside of the first heat-shrinkable tube 51, and the first heat-shrinkable tube 51 is bonded and fixed to the main introduction part 14 and the optical cables 40 by heating the first heat-shrinkable tube 51.

When the first heat-shrinkable tube 51 is heated, the hot melt adhesive 632 of the insertion part 63 inside the first heat-shrinkable tube 51 is heated and melted. Then, the melted hot melt adhesive 632 flows into the gap between the first heat-shrinkable tube 51 and the optical cables 40 and the gap between the two optical cables 40, and the gaps are filled with the hot melt adhesive 632 and sealed. When the first heat-shrinkable tube 51 and the hot melt adhesive 632 after heating cools down, the rear edge of the first heat-shrinkable tube 51 having shrunk by heat, the clip 60, and the cured hot melt adhesive 632 after melting form the seal part 50. In one or more embodiments, the upper and lower edges of the first heat-shrinkable tube 51 before heating are sandwiched by the clip 60, and thus the hot melt adhesive 632 melted during heating easily fills the gaps inside the first heat-shrinkable tube 51, and the seal part 50 is easily formed so as to be airtight.

As illustrated in FIGS. 7B and 7C, the first protective part 81 (part wrapped by the aluminum tape) of each optical cable 40 is formed in a range across the rear edge of the first heat-shrinkable tube 51 when seen from above. In this way, when the rear part of the first heat-shrinkable tube 51 covering the outside of the optical cables 40 is heated, the outer sheaths 44 of the optical cables 40 can be protected by the first protective parts 81, and damage to the outer sheaths 44 of the optical cables 40 can be suppressed. Note that, as illustrated in FIG. 7C, a rear end of each first protective part 81 is disposed to the rear with respect to the clip 60. In this way, as described later, when the front part of the second heat-shrinkable tube 71 is heated, the outer sheaths 44 of the optical cables 40 can be protected by the first protective parts 81.

Next, as illustrated in FIG. 9A, the operator moves the second heat-shrinkable tube 71 previously put to the front. Here, as illustrated in FIG. 7D, the second heat-shrinkable tube 71 is moved to the front until the rear part of the first protective parts 81 on the rear side with respect to the clip 60 is covered by the front part of the second heat-shrinkable tube 71.

Next, the operator heats the second heat-shrinkable tube 71 to shrink. As illustrated in FIG. 9B, the heated second heat-shrinkable tube 71 shrinks, and thus the two optical cables 40 are tied in a bundle by the second heat-shrinkable tube 71. Further, due to the shrinkage of the heated second heat-shrinkable tube 71, the two optical cables 40 are also fixed by the second heat-shrinkable tube 71 over a predetermined length in the front-and-rear direction (length direction). Note that, a hot melt adhesive (not illustrated) is applied to the inside of the second heat-shrinkable tube 71, and the second heat-shrinkable tube 71 is bonded and fixed to the optical cables 40 by heating the second heat-shrinkable tube 71.

As illustrated in FIGS. 7D and 7E, the second protective part 82 (part wrapped by the aluminum tape) of each optical cable 40 is formed in a range across the rear edge of the second heat-shrinkable tube 71 when seen from above. In this way, when the rear part of the second heat-shrinkable tube 71 covering the outside of the optical cables 40 is heated, the outer sheaths 44 of the optical cables 40 can be protected by the second protective parts 82, and damage to the outer sheaths 44 of the optical cables 40 can be suppressed.

In one or more embodiments, as illustrated in FIGS. 7D and 7E, the first protective part 81 of each optical cable 40 is formed in a range across the front edge of the second heat-shrinkable tube 71 when seen from above. In this way, when the front part of the second heat-shrinkable tube 71 is heated, the outer sheaths 44 of the optical cables 40 can be protected by the first protective parts 81. In other words, in one or more embodiments, the first protective parts 81 are provided across the rear edge of the first heat-shrinkable tube 51 and the front edge of the second heat-shrinkable tube 71. Thus, the first protective parts 81 can achieve the functions of both protecting the optical cables 40 while the rear edge of the first heat-shrinkable tube 51 is heated and protecting the optical cables 40 while the front edge of the second heat-shrinkable tube 71 is heated. This facilitates the operation of forming a protective part (operation of wrapping an aluminum tape) further than a case where each optical cable 40 is protected by separate protective parts. Further, a gap between the first heat-shrinkable tube 51 and the second heat-shrinkable tube 71 can be reduced, and thus a shorter connection structure 100 (shorter dimensions from the closure 1 to the rear edge of the second heat-shrinkable tube 71) can be achieved.

After the second heat-shrinkable tube 71 is heated, the operator checks waterproof property of the seal part 50. For example, the operator puts the cover 20 around the base part 10 of the closure 1 and fixes the base part 10 and the cover 20 with the fixing member 30 to make the housing space 1A of the closure 1 airtight. In this state, the operator increases atmospheric pressure inside the closure 1, and then put the closure 1 in the water to check waterproofness and airtightness of the seal part 50.

After checking the waterproof property of the seal part 50, the operator removes the cover 20, fusion-bonds the optical fibers 42A of the optical cable 40A and the optical fibers 42B of the optical cable 40A in order, and houses the connecting sections 43 in the predetermined housing tray 11. After completing the fusion bonding of the respective fibers, the operator puts the cover 20 around the base part 10 of the closure 1 and fixes the base part 10 and the cover 20 with the fixing member 30. In this way, the connection structure 100 is produced.

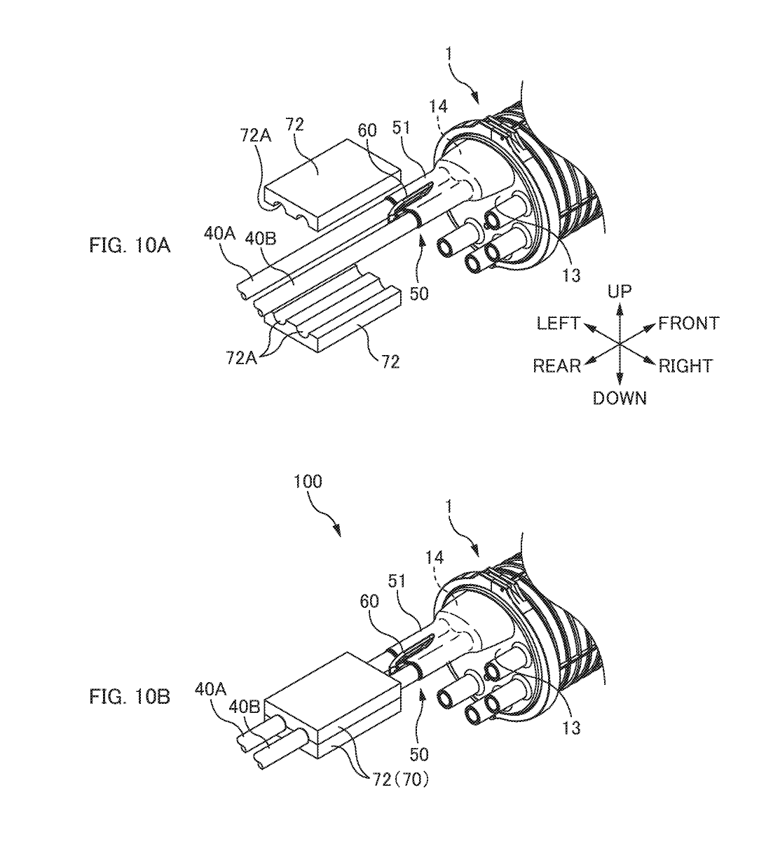

FIGS. 10A and 10B are explanatory diagrams illustrating a connection structure 100 according to one or more embodiments.

In the embodiments described above, the holding part 70 that fixes the two optical cables 40 over a predetermined length to the rear of the seal part 50 is constituted by a heat-shrinkable tube (second heat-shrinkable tube 71). However, the configuration of the holding part 70 is not limited to this. In one or more embodiments, a holding part 70 is constituted by two half members 72.

Each half member 72 includes two grooves 72A. An optical cable 40A and an optical cable 40B are disposed in the two respective grooves 72A. With surfaces of the two half members 72 in which the grooves 72A are formed facing each other and the optical cables 40 being disposed in the grooves 72A, the two optical cables 40 are sandwiched between the two half members 72, and the two half members 72 are fixed. The two half members 72 may be bonded and fixed together with an adhesive or may be fixed by fastening a screw. In one or more embodiments, the half members 72 and the optical cables 40 are bonded and fixed together by applying an adhesive to an inner surface of the grooves 72A of the half members 72. The two optical cables 40 are tied in a bundle with the two half members 72 by fixing the two half members 72. The two optical cables 40 are also fixed by the two half members 72 over a predetermined length in the front-and-rear direction (length direction). As a result, even when bending force or twisting force is applied to the optical cables 40 on the rear side with respect to the holding part 70, the force is less likely to be transmitted to a seal part 50.

In one or more embodiments, the optical cables 40 do not need to be previously inserted through the second heat-shrinkable tube 71 as in the embodiments described above, which facilitates the operation of producing the seal part 50 and the holding part 70.

Other

Although the disclosure has been made with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A connection structure comprising:
a closure including an introduction tube;
two optical cables inserted through the introduction tube;
a seal that closes a gap between the introduction tube and each of the optical cables; and
a holder disposed on a side opposite to the closure when seen from the seal, wherein
the holder fixes the two optical cables over a predetermined length.

2. The connection structure according to claim 1, wherein
the seal comprises:
a heat-shrinkable tube; and
a hot melt adhesive that fills an inside of the heat-shrinkable tube.

3. The connection structure according to claim 2, wherein
the holder comprises a heat-shrinkable tube.

4. The connection structure according to claim 3, wherein
the heat-shrinkable tube of the seal and the heat-shrinkable tube of the holder are constituted by a same member.

5. The connection structure according to claim 3, wherein
the two optical cables comprise:
a first protector that protects the two optical cables when the heat-shrinkable tube of the seal shrinks by heat; and
a second protector that protects the two optical cables when the heat-shrinkable tube of the holder shrinks by heat.

6. The connection structure according to claim 5, wherein
the first protector is disposed at an edge of the heat-shrinkable tube of the seal and at an edge of the heat-shrinkable tube of the holder.

7. The connection structure according to claim 1, wherein
the holder comprises two half members each including a groove in which the two optical cables are disposed.

8. A method of producing a connection structure comprising:
inserting two optical cables through an introduction tube of a closure;
forming a seal that closes a gap between the introduction tube and each of the optical cables; and
forming a holder that fixes the two optical cables over a predetermined length on a side opposite to the closure when seen from the seal.
